(19) United States
(12) Patent Application Publication
(10) Pub. No.: US 2023/0161358 A1
(43) Pub. Date: May 25, 2023

(54) METHOD AND SYSTEM FOR UPDATING AND CALIBRATING CURRENT POSITION OF A CONTROLLABLE ROLLING DEVICE

(71) Applicant: WHEEL.ME AS, Oslo (NO)

(72) Inventors: Abyl IKHSANOV, Oslo (NO); Atle TIMENES, Snarøya (NO)

(21) Appl. No.: 17/908,671

(22) PCT Filed: Mar. 3, 2021
(86) PCT No.: PCT/EP2021/055369

§ 371 Date: Sep. 1, 2022

(30) Foreign Application Priority Data
Mar. 3, 2020 (EP) 20160640.7
Oct. 21, 2020 (NO) 20201139

(51) Int. Cl. G05D 1/02; G01S 17/89

(52) U.S. Cl. CPC G05D 1/0287; G05D 1/0272; G05D 1/0274; G05D 1/0253; G01S 17/89

(57) ABSTRACT

A method, system and computer program for updating a position of a remotely controlled rolling device operating in an area together with a plurality of other identical remotely controlled rolling devices, the rolling devices comprises a housing with a rolling element arranged at a first end portion of the housing and where the other end of the housing is inserted into an object to become integrated with the object such that the object is made remotely controllable and movable when the rolling element is in contact with a surface; communication means, control device, sensors and position detection means, driving means 60 and power supply, all of which are connected to each other and installed in the housing. The system comprises a plurality of said rolling devices; and an access point connected to a database server configured to update and calibrate positions of rolling devices.

### INTRODUCTION

The present invention relates to remotely controlled rolling devices that when integrated in an object makes the object movable and more specifically to a method, system and computer program for updating and calibrating the position of a rolling device operating in a defined area together with a plurality of other similar rolling devices.

### BACKGROUND

The applicant has previously developed a rolling device capable of being integrated in furniture and other objects making them movable and remotely controlled.

When said rolling device is integrated in an object, the footprint of the object will remain the same as before integration. There is thus no additional area occupied by the objects when made movable. This device is described in EP 3355148 B1 and is hereby included as reference.

More specifically, the rolling device comprises a housing adapted for being integrated in the object to be moved. A rolling element is arranged at a first end portion of the housing. The rolling element can for instance be a ball or a wheel. The other end of the housing is inserted into the object to make it movable. In this way, the rolling device is integrated in for instance the leg of a chair or table.

The rolling device further comprises a wireless receiver and a control device connected to each other as well as position detection means connected to the control device for acquiring the position of the rolling device. Driving means are connected to the control device and a power supply is connected to the devices arranged in the housing. The power supply is a chargeable battery. This rolling device is called an active rolling device in contrast to a rolling device without driving means, called a passive rolling device.

For a chair, each leg will require a rolling element for easily moving it on a flat surface such as a floor. For making the chair autonomously moveable, it is sufficient to install and integrate only one active rolling device with controllable driving means in one of the legs of the chair. The other legs can be fitted with passive rolling devices comprising only a rolling element. This solution enables an active rolling device to be moved by remotely controlling it, thereby moving the chair autonomously. The passive rolling devices will follow the movements of the active rolling device.

For better controlled movements of an object, two or more active rolling devices are integrated in the object. This makes it easier to move and manoeuvre objects with integrated rolling devices from one position to another without them bumping into each other.

In either case, when several rolling devices are operating within the same confined area, such as a room in a building, precise estimation of the position of the active rolling devices is essential.

Different types of position detection means are described in EP 3355148 B1. One example is determining position by means of an external device observing positions of rolling devices and the objects they are integrated in. Different methods can be used for this. One example is to use a camera, preferably a 3D camera. Another way is to apply Bluetooth indoor positioning by means of triangulation. This is possible by equipping active rolling devices with a Bluetooth transmitter, and arranging at least three antennas in the room where the rolling devices are.

When using an active rolling element with internal sensors and positioning detection means for determining its position when moving around in an area, its actual position may deviate from the determined position. This may be due to drift in the position detection means and accumulated estimation errors. This will most likely accumulate over time.

When there are several active rolling devices operating in same area, e.g. an indoor environment, there is a need for a simple and efficient way of determining a precise and updated position of the rolling devices for precise maneuvering of the objects they are integrated in to avoid collisions.

The present invention proposes a solution where an active rolling device, that is a remotely controlled rolling device uses recent updated reference positions of other active rolling devices.

### SUMMARY OF THE INVENTION

The invention is defined by a method for updating a position of a remotely controlled rolling device operating in an area together with a plurality of other identical remotely controlled rolling devices, the rolling devices comprises:
a housing with a rolling element arranged at a first end portion of the housing and where the other end of the housing is inserted into an object to become integrated with the object such that the object is made remotely controllable and movable when the rolling element is in contact with a surface,
communication means, control device, sensors and position detection means, driving means and power supply, all of which are connected to each other and installed in the housing.

The method comprises the following steps:
acquiring a reference position (X) of all the rolling devices in the area;
driving the rolling devices around in the area and updating, by means of the position detection means, their current positions in the area relative to the reference position (X) and transmitting a time stamped current positions to a database server, where a time stamp defines the time a rolling device has driven since departure from the reference position (X);
detecting, for each rolling device, if other rolling devices are nearby by means of the communication means, and if so, identifying the one or more detected rolling devices and retrieving their time stamp from the database server;
checking, for each rolling device, if time stamps of the one or more detected and identified nearby rolling devices indicate less driving time, since departure from the reference position (X), than indicated by its own time stamp, and if so, requesting the current positions of the detected and identified rolling devices from the database server;
updating current position of a rolling device by determining its current position relative to positions of, and distances to the one or more detected and identified nearby rolling devices, having a time stamp indicating less driving time since departure from the reference position (X);
updating the database server with an updated current position of the rolling device.

In one embodiment, mapping of the area where the remotely controlled rolling devices are operating is performed by using LiDAR for defining a digital dimensional model of the area.

In one embodiment, the reference position is defined as the position where a charging station for the rolling device is located.

In another embodiment, the reference position is defined by using a range imaging camera directed at the area which the rolling device is operating in.

In one embodiment, nearby rolling devices are identified by receiving coded light transmitted from the nearby rolling devices.

In one embodiment, current position of the rolling device is acquired by using encoders in the rolling device providing relative angle and rotation information, and by calculating the current position based on a previously determined position and advancing that position based upon the angle and rotational information.

In one embodiment, the position of the rolling device is determined by means of a camera directed at the rolling device and the defined area where it is operating in.

In one embodiment, the current position of the rolling device is updated by combining position information acquired from the encoders and the camera and applying Kalman filtering for removing noise.

In one embodiment, a calibrating rolling device is provided by frequently updating its position data at the reference position of the rolling devices, and where the calibrating rolling device is driven around in the defined area for providing updated position information to other rolling devices 10.

In one embodiment, a UWB chip is used as a sensor for detecting one or more rolling devices as well as determining distance to these.

The present invention is further defined by a system for updating a position of a remotely controlled rolling device operating in an area together with a plurality of other similar rolling devices. The rolling device comprises:
a housing with a rolling element arranged at a first end portion of the housing and where the other end of the housing is inserted into an object to become integrated with the object such that the object is made remotely controllable and movable when the rolling element is in contact with a surface;
communication means, control device, sensors and position detection means, driving means and power supply, all of which are connected to each other and installed in the housing.

The system further comprises:

an access point connected to a database server configured to update and calibrate positions of rolling devices operating in the defined area when running a computer program on the database server performs the method described above.

The invention is further defined by a computer program that when executed by a database server performs the method described above for updating a position of a remotely controlled rolling device operating in same area together with a plurality of other similar rolling devices.

### DETAILED DESCRIPTION OF THE INVENTION

In the following, the invention will be discussed and explained in more detail with reference to the appended figures and examples of implementations. It should be understood, however, that the drawings are not intended to limit the invention to the subject-matter depicted.

As mentioned, the applicant has previously developed a rolling device capable of being integrated in furniture and other objects making them movable and remotely controlled while the footprint of the object remains the same as before integration.

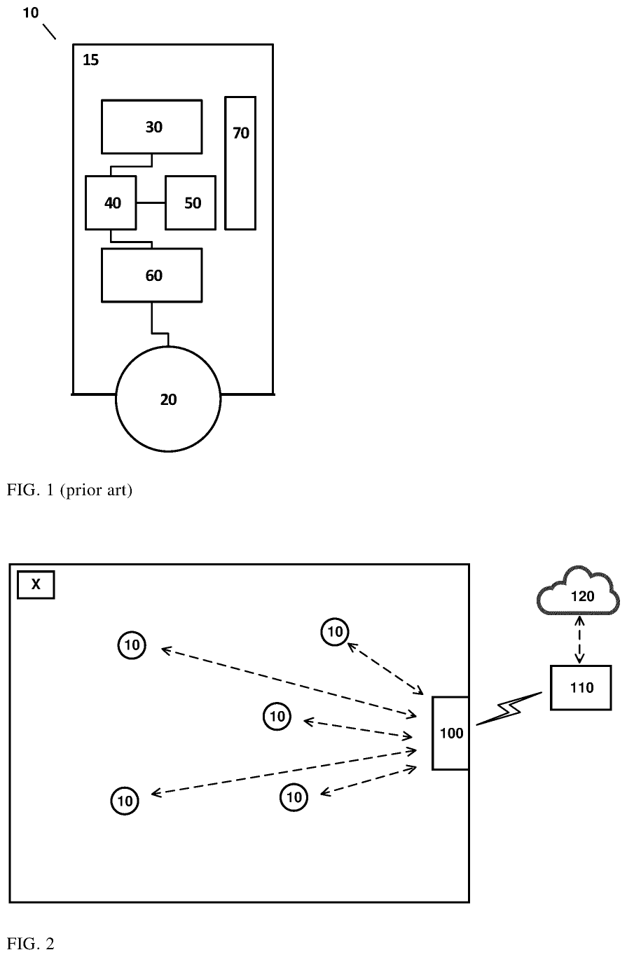

FIG. 1 shows the different components comprised in the rolling device 10. The rolling device 10 comprises a housing 15, a rolling element 20 that is arranged at a first end portion of the housing 15 and where the other end of the housing is inserted into an object to become integrated with the object such that the object is made remotely controllable and movable when the rolling element 20 is in contact with a surface.

The rolling device 10 further comprises communication means 30, a control device 40, sensors and position detection means 50, driving means 60 and power supply 70, all of which are connected to each other and installed in the housing 15.

The rolling element 20 installed in the rolling device 10 can be of any type such as a ball or a wheel that is driven by driving means 60, such as an electromotor, ensuring that the rolling element 20 can be driven in any direction. Direction and speed are controlled by the control device 40 according to driving instructions received via the communications means 30 communicating with a remote controlling device. The communication means 30 can be of any known type such as Bluetooth of WiFi. The remote controlling device may for instance be a tablet or a smart phone running application for controlling different scenarios for moving the rolling devices around in a defined area. In this way rolling devices 10 are remotely operated and controlled according to received wireless control signals comprising movement instructions.

The power supply 70 for driving the different electronic components arranged in the housing 15 is typically a rechargeable battery. Inductive wireless power transfer can be used for charging the rechargeable battery. A receiver for receiving electromagnetic field energy is in this embodiment placed in the housing 15 of the rolling device 10.

There are different ways of acquiring the position of a rolling device 10 moving around in an area. One way is by using internal means, e.g. motion detection sensors, installed in the rolling device 10. Another way is by using external means such as a camera. Internal means are preferred when there are many rolling devices operating in the same area, e.g. several hundred.

Internal sensors and position detection means 50 keep track of the position of rolling device 10 in the area it is operating in. Wheel encoders and inertial measurement units (IMU) are used as motion detection sensors and odometry is used for determining a current position based on generated data from the sensors.

Wheel encoders are used to detect rotation of the rolling device 20 enabling estimation of the distance travelled from a starting position. An IMU is used for estimating the orientation of the rolling device 20 and thus the direction (angle) while another IMU (wheel IMU device 200) is used for detecting any possible slippage of the rolling device, i.e. when the wheel is spinning but the rolling device is not moving in any direction. Wheel IMU device 200 detects the slippage because it is attached directly to the rolling device 20 and measures the acceleration and the velocity of the rolling device 10, if the rolling device 20 starts rolling (accelerating) but the wheel IMU device 200 does not detect any acceleration. This means that a wheel slippage occurred.

Odometry is used to estimate change in position over time based on the data generated from the wheel encoders and IMU sensors. In this way the current position of a rolling device 10 relative to a starting location can be estimated. The current position of the rolling device can be calculated by using a previously determined position, direction and travelled distance. This is known as Dead Reckoning.

Odometry is however sensitive to errors due to the integration of velocity measurements over time to give position estimates.

A more accurate method for determining the position of a rolling device 10 is achieved by combining said internal method with an external method for determining position. By combining data from various navigation systems having different physical principles one can increase the accuracy and robustness of the overall solution. By combining physical and mathematical methods, problems related to noise and drift can be alleviated. One may for instance combine Inertial Measurement Unit (IMU and wheel IMU) and Monocular Camera Simultaneous localization and mapping (SLAM).

Combining sensor data derived from separate sources is known as Sensor Fusion, where the resulting data has less uncertainty than would be possible when the sources were used individually.

Since not all sensors are identical and further generate some noise, the noise and variances can be modeled, and the noise can be combined into the Kalman filter to reduce the noise and enhance the accuracy of the odometry. First, camera odometry and relative angle, i.e. travelling direction of the rolling device 10, derived from IMU are fused via Kalman filtering to get the best angle. At the same time, wheel encoders are fused together with wheel rotation given by wheel IMU to get the best translational distance driven. After that, the output from the two methods will be fused to get a final filtered overall odometry resulting in a more precise determination of the position of a rolling device 10. Note that the combination of sensor fusion can be different, but the core sensors will remain the same.

In the following, the invention will be explained in more detail with reference to FIG. 2.

FIG. 2 illustrates an example of a system for updating and calibrating the position of a remotely controlled rolling device 10 operating in an area together with a plurality of other similar rolling devices 10. The area is in this example illustrated as a room where five rolling devices 10 are integrated in objects thereby making the objects 10 remotely controllable and movable. The different components comprised in a rolling device 10 is described above with reference to FIG. 1.

The system illustrated in FIG. 2 comprises five rolling devices 10 enabled for two-way communication with a database server 110 via an access point 100. Each indicated rolling device 10 may represent a set of rolling devices 10 integrated in the same object, e.g. a chair, and where one rolling device 10 in the set of rolling devices 10 is operating as a master rolling device 10 for the others. In a set of rolling devices 10, a master rolling device 10 will receive information from the other rolling devices 10 and transmit coordinated information to database server 110 via the access point 100. At least one rolling device 10 in a set of rolling devices 10 needs to have IMUs to determine the moving direction of a set of rolling devices integrated in the same object.

The access point 100 is connected to and communicating with a database server 110 configured to update and calibrate positions of rolling devices 10 and to transmit control instructions to the rolling devices 10 operating in the area. The database server 110 may be remotely located, and data may be stored in the cloud 120, i.e. a cloud computing system.

The inventive method for updating and calibrating the position of a remotely controlled rolling device 10 comprises several steps.

A first step is acquiring a reference position X for all rolling devices 10 in a defined area they are operating in. The area can be of any shape and can be mapped by using different techniques. If an updated layout map of the area already exists, mapping can be based on this. A mapped area can be stored in the database server 110.

A precise mapping of the area where the remotely controlled rolling devices 10 are operating can in one embodiment be performed by using LiDAR, i.e. Light Detection and Ranging. By illuminating an area with laser light and measuring the reflected light with a sensor, a digital dimensional model of the area can be made.

When the area that the rolling devices 10 are going to operate in is defined or mapped, a reference position X of the rolling device 10 in the area is established. This reference position, marked as X in the example shown FIG. 2, represents a precise known position for a rolling device 10 when the rolling device is positioned at the reference position X. A reference position X is equipped with an ID that can be recognized by a rolling device 10, e.g. by detecting an RFID or a blinking pattern from a LED.

Any errors or drift in sensors in the rolling device 10 used for determining its current position will be calibrated by resetting its registered current position when it is at the reference position X. Errors in calculated positions will increase according to the time a rolling device has driven since departure from last calibration of position at a reference position X.

In one embodiment, the reference position X is a position of a charging station for the rolling device 10. A rolling device 10 typically has a rechargeable battery that must be charged when running low on power. The rolling device 10 will then drive to a charging station to be recharged. The charging station is preferable a wireless charging station providing energy via inductive power. When at the charging station, it will update its position and time stamp this, e.g. position is (40, 45) at time 00:00. Driving times elapsed for a rolling device after leaving the reference position X will be recorded as time stamps together with current position and identification of the rolling device 10. For instance, after 10 s with driving time since last charging at the charging station, the position is (125,211) and time stamp is 00:10.

When a rolling device 10 is located at a reference position X, a current calculated position of the rolling device 10 is updated to the position of the reference position X. Since the battery of a rolling device 10 needs to be recharged every now and then, typically after 3 hours of operation, the position of the rolling device 10 will always be reset before 3 hours of operation. In the meantime, its actual position of the rolling device 10 may deviate from calculated position based on data from its sensors and position detection means 50. The amount of deviation from actual position in the defined area is expected to increase the longer the rolling device has been driven since last position update at a reference position X.

When there is a plurality of rolling devices 10 operating in the same area, they will require recharging at different times depending on how much power they have used. The time each rolling device 10 has driven since they were recharged and thus were calibrated at a reference position X will therefore be different for each rolling device 10. The less time driving since last charging of a rolling device 10 means less possible deviation of a calculated current position of a rolling device 10 from its actual current position.

In one embodiment, one or more reference points X may be provided in the defined area by using a range imaging camera directed at the area a rolling device 10 is operating in. The camera can identify very small features on a floor and track a distance between them, thereby providing precise position information of the rolling device 10.

When a rolling device 10 is being operated, it will drive around in the defined area and the position detection means of the rolling device 10 will update and time stamp its current position in the area relative to the reference position X. As mentioned, the time stamp defines the time the rolling device 10 has driven since departure from the reference position X.

In one embodiment, the current position of a rolling device 10 is acquired by means of encoders in the rolling device 10 where a first encoder provides relative angle and a second encoder provides rotation information. The current position of the rolling device is calculated by using a previously determined position and advancing that position based upon the angle and rotational information of the rolling device, ref. dead reckoning.

In another embodiment, the current position of a rolling device 10 is determined by means of a camera directed at the rolling device 10 and the defined area where it is operating. From pictures taken by the camera, the position of rolling devices can be found in the defined area and/or recognizable features in the floor or surroundings.

In one embodiment, positions are determined by combining different method, such as using encoders, dead reckoning and cameras to achieve a more precise estimation. Kalman filtering of data received when using the different methods can be used to further reduce noise.

When setting up the system, each rolling device 10 operating within the same defined area is registered in the database server 100 with its unique signature.

The next step of the method is detecting if other rolling devices 10 are nearby by means of the communication means 30, and if so, identifying the one or more detected roller devices 10 and retrieving their time stamp from the database server 110.

Different detection means can be used for detecting and identifying nearby rolling devices 10. According to one embodiment, nearby rolling devices 10 are identified by receiving coded light transmitted from the nearby rolling devices 10. In this embodiment, rolling devices 10 comprises a pulsed light source such as LED where each rolling device operating in the same defined area is adapted to transmit a unique identifiable pulsed light with a unique signature.

According to another embodiment, nearby rolling devices 10 are identified by means of RFID. In this embodiment, the rolling devices 10 comprises RFID chips.

When a nearby rolling device 10 is detected and identified, a request of the identified rolling device 10 is transmitted to the database server 110 which stores updated data of the identity, position and time stamp of all rolling devices 10 operating in the defined area. The time stamp of the rolling device 10 detecting and identifying the nearby rolling device 10 is compared with the time stamp of the nearby detected rolling device 10. If it is found that a detected nearby rolling device 10 has a time stamp indicating less driving time since departure from the reference position X, the position of the detected nearby rolling device 10 is requested from the database server 110 and the current position of the rolling device 10 is updated in the database server 110 based on the position of the nearby rolling device 10.

An updated position for a rolling device 10 is found by determining its current position relative to positions of, and distances to one or more detected and identified nearby rolling devices 10, having a time stamp indicating less driving time since departure from the reference position X.

Distance to other rolling devices 10 can be determined by different technologies such as emission and reflection of sound waves, e.g. with an ultrasound transducer implemented in each rolling device 10. Another example is emission and reflection of light pulses.

A preferred solution for determining distance between rolling devices 10 is using an Ultra-wideband (UWB) chip integrated in each rolling device 10. UWB is a radio technology requiring very low energy that is used for short-range communication. Signals can be detected from one rolling device once they are for instance 12 cm from each other.

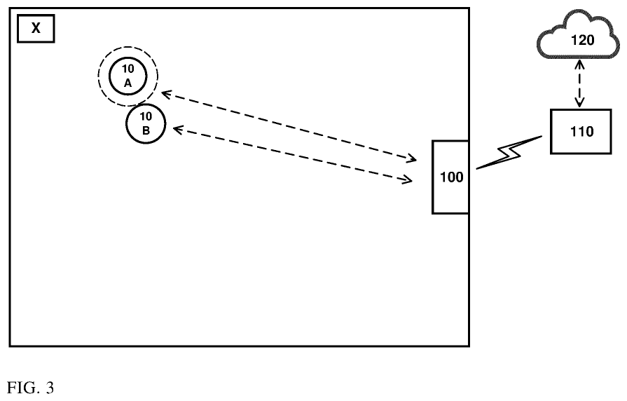

FIG. 3 illustrates an example of how a rolling device 10 B can update its position relative to the position of rolling device 10 A. Once rolling device 10 B crosses the dotted circle illustrated around rolling device 10 A, rolling device 10 A is detected and identified by rolling device 10 B. Identification of rolling device 10 A is recorded and a request for the time stamp of rolling device 10 A is sent to the database server 110 along with the identification of rolling device 10 B. The database server will compare the time stamps of both rolling devices 10.

In this example it is concluded that the time stamp of rolling device 10 A indicates less driving time than rolling device 10 B since last calibration and update of their positions at the reference position X. Current position of rolling device 10 B relative to current position of rolling device 10 A when detecting rolling device 10 A, determines where on the dotted circle rolling device is relative to rolling device 10A. Since the distance between the rolling devices is known, i.e. once detection of another rolling device occurs, an updated position of rolling device 10 B is calculated and the database server 110 is updated with the updated position of rolling device 10 B.

As an example, the rolling devices 10 described above are integrated in objects such as pallets, tables and chairs, all in the same defined area, e.g. a storage room. It is expected that some of these objects will be moved more frequently than the others. Suppose that a rolling device A that is integrated in a pallet detects and identifies another rolling device B, integrated in a table, and that the time stamp of B indicates a shorter driving time since departure from a reference position X, meaning that B has accumulated less error than A. If so, rolling device A requests the database server 110, e.g. by retrieving data from the cloud 120, the position of B at current time and correct A's position relative to B's position.

If a rolling device 10 detects and identifies several nearby rolling devices 10, the actual position of the rolling device 10 can be further optimized by comparing timestamps and positions of nearby identified rolling devices 10 before calculating an updated and calibrated position of the rolling device 10. The rolling device 10 may for instance detect and identify three other rolling devices 10 and their positions. It is then found that the other rolling devices 10 have time stamps close to each other, indicating that their driving time since being at a reference point is similar, and that that the rolling device 10 is surrounded by the detected and identified rolling devices 10. The position of the rolling device 10 can then be calculated to be in the center of a triangle defined by the three detected rolling devices 10.

In another embodiment, a dedicated calibrating rolling device 10 is assigned to drive around in the defined area for providing updated position information to other rolling devices 10. In this embodiment, the calibrating rolling device 10 frequently updates and calibrated its own position at a reference point X, typically when it detects that the driving time since departure from its reference position is above a set limit, for instance more than 5 minutes driving time since last calibration at the reference point X. In this way, the calibrating rolling device 10 can be controlled to have a time stamp indicating less driving time than most other driving devices operating in the defined area.

The present invention is further defined by a computer program that when executed by the database server 110 performs the method described above for updating and calibrating the position of a remotely controlled rolling device 10 operating in an area together with a plurality of other similar rolling devices 10.

In one embodiment, the computer program is installed and run in the database server 110 and is controlled via a device communicating with the database server 110. This device may for instance be a tablet or smart phone running an App for controlling positions of objects with integrated rolling devices 10.

The system, method and computer program described above provides a way of updating current position of rolling devices 10 operating in a defined area, thereby providing a more precise positioning of objected with integrated rolling devices.

The system may comprise hundreds of rolling devices 10 integrated in objects to be moved within same area and where the position of each rolling device 10 is continuously updated by the inventive method.

1. A method for updating position of remotely controlled rolling device operating within a same defined area, the remotely controlled rolling devices being similar, each rolling device comprises:
a housing with a rolling element arranged at a first end portion of the housing and where the other end of the housing is inserted into an object to make the object movable and where the rolling element is in contact with a surface when the rolling device is integrated in the object,
communication means, control device, sensors and position detection means, driving means and power supply, all of which are connected to each other and installed in the housing;
wherein the method comprises the following steps:
acquiring position information for all the rolling devices operating in the area relative to a reference position within the area;
driving the rolling devices around in the area and updating, by means of the position detection means, their current positions in the area relative to the reference position and transmitting time stamped current positions to a database server, where a time stamp defines the time a rolling device has driven since departure from the reference position;
detecting, for each rolling device, if other rolling devices are nearby by means of the communication means, and if so, identifying the one or more detected rolling devices and retrieving their time stamp from the database server;
checking, for each rolling device, if time stamps of the one or more detected and identified nearby rolling devices indicate less driving time, since departure from the reference position, than indicated by its own time stamp, and if so, requesting the current positions of the detected and identified rolling devices from the database server;
updating, by means of the sensors and position detection means, current position of each rolling device by determining their current positions relative to positions of, and distances to the one or more detected and identified nearby rolling devices having a time stamp indicating less driving time since departure from the reference position;
updating the database server with an updated current position of the rolling devices.

2. The method according to claim 1, mapping of the area where the remotely controlled rolling devices are operating by using LiDAR for defining a digital dimensional model of the area.

3. The method according to claim 1, defining the reference position as the position where a charging station for the rolling devices is located.

4. The method according to claim 1, identifying nearby rolling devices by receiving coded light transmitted from the nearby rolling devices.

5. The method according to claim 1, acquiring current position of a rolling devices by using encoders in the rolling device providing relative angle and rotation information, and by calculating the current position based on a previously determined position and advancing that position based on angle and rotational information.

6. The method according to claim 1, determining position of the rolling device by means of a camera directed at the rolling device and the defined area where it is operating in.

7. The method according to claim 6, updating current position of the rolling device by combining position information acquired from the encoders and the camera and applying Kalman filtering for removing noise.

8. The method according to claim 7, providing a calibrating rolling device, frequently updating its position data at the reference position, and where the calibrating rolling device is driven around in the define area for providing updated position information to other rolling devices.

9. (canceled)

10. The method according to claim 1, using a UWB chip as a sensor for detecting one or more rolling devices as well as determining distance to these.

11. A system for updating position information of remotely controlled rolling devices operating within an area, the system comprises similar remotely controlled rolling devices, each rolling device comprises:
a housing with a rolling element arranged at a first end portion of the housing and where the other end of the housing is inserted into an object to make the object movable and where the rolling element is in contact with a surface when the rolling device is integrated in the object;
communication means, control device, sensors and position detection means, driving means and power supply, all of which are connected to each other and installed in the housing;
wherein the system further comprises:
an access point connected to a database server, where the access point provides two-way communication between the database server and the rolling devices, and where the database server is configured to receive time stamped current positions from the rolling devices and to update and calibrate positions of rolling devices operating within the defined area when running a computer program performing the method according to claim 1.

12. (canceled)
